(19) United States
(12) Patent Application Publication
(10) Pub. No.: US 2017/0198831 A1
(43) Pub. Date: Jul. 13, 2017

(54) SYSTEM AND METHOD FOR MONITORING PERFORMANCE OF RELIEF VALVES IN A HYDRAULIC SYSTEM

(71) Applicant: Caterpillar Inc., Peoria, IL (US)

(72) Inventors: Matthew Beschorner, Plainfield, IL (US); Naoto Funabiki, Hyogo-Ken (JP); Brett Janson, Hanna City, IL (US)

(73) Assignee: Caterpillar Inc., Peoria, IL (US)

(21) Appl. No.: 14/992,452

(22) Filed: Jan. 11, 2016

(51) Int. Cl. F16K 37/00; G01M 3/28; F16K 17/02

(52) U.S. Cl. CPC F16K 37/0091; F16K 37/0083; F16K 17/02; G01M 3/2876

(57) ABSTRACT

A system for monitoring performance of a relief valve in a hydraulic system having a hydraulic actuator includes a supply discharge line fluidly coupled between a source of pressurized fluid and a fluid chamber of the actuator. The supply discharge line has a supply valve disposed therein. The system also includes a main relief line and a line relief line fluidly coupled to the supply discharge line. The main relief line includes a main relief valve and is disposed upstream of the supply valve while the line relief line includes a line relief valve and is disposed downstream of the supply valve. The line relief valve is configured to open at a pressure value greater than that used in the main relief valve. A controller compares fluid pressures in the main relief line and the line relief line to determine if the line relief valve is leaking.

### TECHNICAL FIELD

The current disclosure relates to a performance monitoring system, and more particularly to a system for monitoring performance of relief valves in a hydraulic system.

### BACKGROUND

Machines such as hydraulic excavators are used to perform various operations such as, digging, dumping or hauling of materials at a worksite. Such machines may typically employ relief valves in their hydraulic systems to control a work implement and perform one or more of the aforesaid operations. An operator may provide one or more inputs indicative of a desired position or movement of the implement. Accordingly, the implement may be tilted and/or rotated using one or more hydraulic actuators, for example a pair of hydraulic cylinders based on the input/s from the operator.

The relief valves may be configured to provide relief in the respective fluid pressures by way of various pre-defined settings or commands from a controller. For reference, U.S. Pat. No. 7,204,084 relates to a hydraulic system for a work machine. The hydraulic system has a source of pressurized fluid and a fluid actuator with a first chamber and a second chamber. The hydraulic system also has a first valve configured to selectively fluidly communicate the source with the first chamber and a second valve configured to selectively fluidly communicate the source with the second chamber. The hydraulic system further has a proportional pressure compensating valve configured to control a pressure of a fluid directed between the source and the first and second valves.

However, over time and/or upon prolonged use, relief valves may be subject to spikes in pressure and may thereafter fail to operate as intended. Failure of the relief valves to operate may, in turn, hamper the functioning of the respective hydraulic systems. A diagnosis may be required to ascertain which and/or how many relief valves in a given hydraulic system have failed. However, in some cases, it may become cumbersome and/or tedious for service personnel to perform diagnosis when a large number of relief valves are present in the hydraulic system.

Hence, there is a need for a system and a method that can assist in monitoring the performance of each relief valve of a given hydraulic system quickly and with ease while reducing an amount of effort and time entailed in such performance monitoring.

### SUMMARY OF THE DISCLOSURE

In one aspect of the current disclosure, a system for monitoring performance of a relief valve in a hydraulic system having at least one hydraulic actuator includes a source that is configured to provide a supply of pressurized fluid. The system further includes a supply discharge line fluidly coupled between the source and a fluid chamber of the actuator. The system further includes a main relief line fluidly coupled to the supply discharge line. The main relief line has a main relief valve disposed therein. The main relief valve is configured to regulate a pressure of the fluid from the source below a first pressure value.

The system further includes an electronically controlled supply valve disposed downstream of the main relief line and fluidly coupled to the supply discharge line. The supply valve is configured to selectively communicate pressurized fluid from the source to the fluid chamber of the actuator. The system also includes a line relief line that is disposed between the fluid chamber of the actuator and the supply valve and fluidly coupled to the supply discharge line. The line relief line has a line relief valve that is configured to open at a second pressure value greater than the first pressure value to selectively facilitate fluid communication between the fluid chamber of the hydraulic actuator and a tank. The system further includes a bypass line fluidly coupled to the supply discharge line and disposed between the main relief line and the supply valve. The bypass line includes a bypass valve disposed therein. The bypass valve is configured to selectively allow fluid communication between the supply discharge line and at least one of: a second hydraulic actuator and the tank.

The system further includes a first pressure sensor coupled to the supply discharge line and disposed upstream of the supply valve to indicate a fluid pressure of the main relief line. The system also includes a second pressure sensor coupled to the line relief line and disposed upstream of the line relief valve to indicate a fluid pressure of the line relief line. The system further includes a controller that is disposed in communication with the supply valve, bypass valve, the first pressure sensor, and the second pressure sensor.

In one embodiment, the controller is configured to move the supply valve to an open position correlating to a maximum pressure drop across the supply valve; provide the supply of pressurized fluid from the source; move the bypass valve to an open position associated with a desired flow rate from the source; determine the fluid pressure of the main relief line; determine the fluid pressure of the line relief line; compare the fluid pressures of the main relief line and the line relief line; and determine leakage across the line relief valve on the basis of a difference between the fluid pressures of the main relief line and the line relief line.

In another embodiment, the controller is configured to move the supply valve to an open position correlating to a minimum to zero pressure drop across the supply valve; provide the supply of pressurized fluid from the source; move the bypass valve to an open position associated with a desired flow rate from the source; determine a pressure of fluid in the line relief line; compare the pressure of fluid in the line relief line from the second pressure sensor with the second pressure value associated with the line relief valve; and determine if the line relief valve is opening at the second pressure value on the basis of a difference between the pressure of fluid in the line relief line and the second pressure value at which the second relief valve is set to open.

In another aspect of this disclosure, a method for monitoring performance of a relief valve in a hydraulic system having a hydraulic actuator includes providing a supply of pressurized fluid from a source to an actuator via a supply discharge line; and moving a supply valve to an open position correlating to a maximum pressure drop across the supply valve, wherein the supply valve is fluidly coupled to the supply discharge line between the source and the actuator. The method further includes moving a bypass valve of a bypass line to an open position associated with a desired flow rate from the source, wherein the bypass line is coupled to the supply discharge line, the bypass line being disposed upstream of the supply valve and downstream of the source.

Moreover, the method includes determining a fluid pressure of a main relief line, wherein the main relief line is fluidly coupled to the supply discharge line, the main relief line being disposed upstream of the bypass line and downstream of the source, the main relief line having a main relief valve disposed therein. The method further includes determining a fluid pressure of a line relief line, wherein the line relief line is fluidly coupled to the supply discharge line, the line relief line being disposed downstream of the supply valve and upstream of the actuator, the line relief line comprising a line relief valve disposed therein. The method then includes comparing the fluid pressure of the main relief line and the fluid pressure of the line relief line; and determining if there is a leakage across the line relief valve on the basis of a difference between the fluid pressures of the main relief line and the line relief line.

Other features and aspects of this disclosure will be apparent from the following description and the accompanying drawings.

### BRIEF DESCRIPTION OF THE DRAWINGS

FIG. 1 is a side view of an exemplary machine showing a work implement; and

FIG. 2 is a schematic of a hydraulic system of the exemplary machine, to which a system for monitoring performance of relief valves from the present disclosure can be implemented; and

FIG. 3 is a flowchart of a method for monitoring performance of relief valves, according to an embodiment of the current disclosure.

### DETAILED DESCRIPTION

Reference will now be made in detail to specific aspects or features, examples of which are illustrated in the accompanying drawings. Wherever possible, corresponding or similar reference numbers will be used throughout the drawings to refer to the same or corresponding parts.

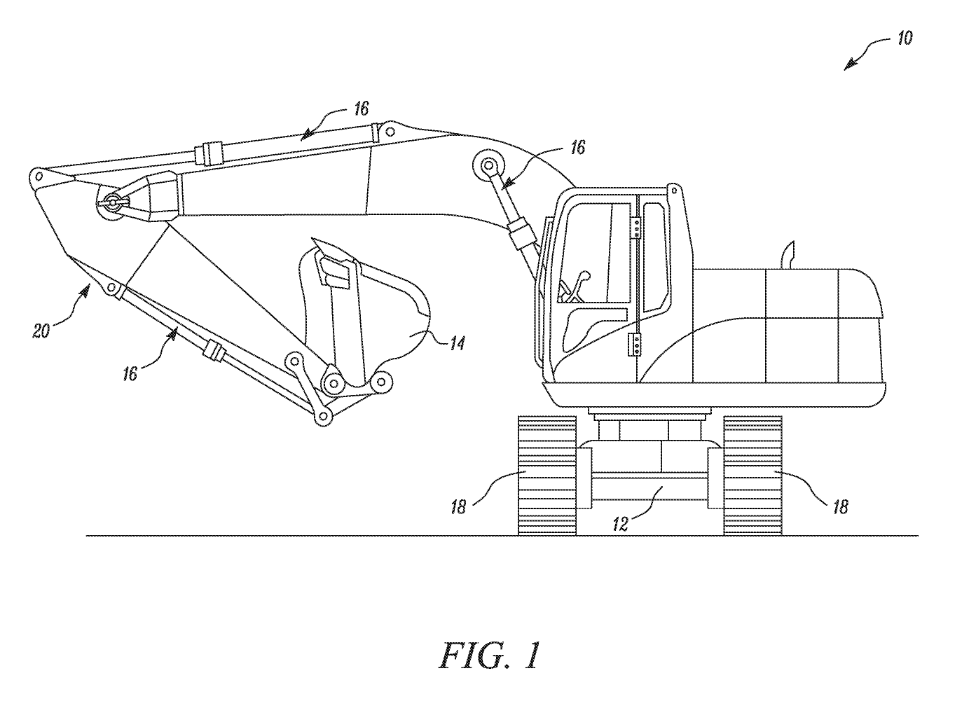

FIG. 1 illustrates an exemplary work machine 10. Work machine 10 may be a fixed or mobile machine that performs some type of operation associated with an industry such as mining, construction, farming, or any other industry known in the art. For example, work machine 10 may be an earth moving machine such as a dozer, a loader, a backhoe, an excavator, a motor grader, a dump truck, or any other earth moving machine. Work machine 10 may also include a generator set, a pump, a marine vessel, or any other suitable operation-performing work machine. Work machine 10 may include a frame 12, at least one work implementl4, and a hydraulic actuator 16 connecting work implement 14 to frame 12. It is contemplated that hydraulic actuator 16 may be omitted, if desired, and a hydraulic motor included.

Frame 12 may include any structural unit that supports movement of work machine 10. Frame 12 may be, for example, a stationary base frame connecting a power source (not shown) to a traction device 18, a movable frame member of a linkage system, or any other frame known in the art.

Work implement 14 may include any device used in the performance of a task. For example, work implement 14 may include a blade, a bucket, a shovel, a ripper, a dump bed, a propelling device, or any other task-performing device known in the art. Work implement 14 may be connected to frame 12 via a linkage system 20 with hydraulic actuator 16 forming one member in the linkage system, or in any other appropriate manner known to persons skilled in the art. Work implement 14 may be configured to pivot, rotate, slide, swing, or move relative to frame 12 in any other manner known in the art.

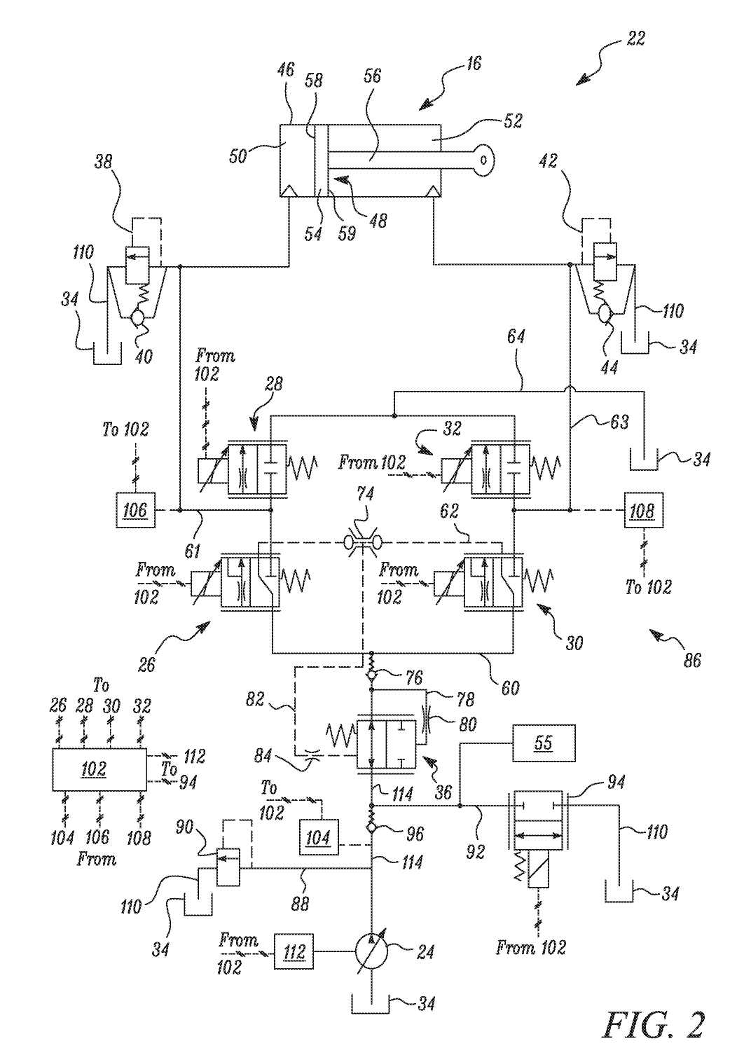

As illustrated in FIG. 2, hydraulic actuator 16 may be one of various components within a hydraulic system 22 that cooperate to move work implement 14. Hydraulic system 22 may include a source 24 of pressurized fluid, an actuator valve system 86, a tank 34, a proportional pressure compensating valve 36, and a plurality of line relief valves 38, 42. It is also contemplated that hydraulic system 22 may include additional and/or different components such as, for example, a temperature sensor, a position sensor, an accumulator, and other components known in the art.

Hydraulic actuator 16 may include a tube 46 and a piston assembly 48 disposed within tube 46. One of tube 46 and piston assembly 48 may be pivotally connected to frame 12, while the other of tube 46 and piston assembly 48 may be pivotally connected to work implement 14. It is contemplated that tube 46 and/or piston assembly 48 may alternately be fixedly connected to either frame 12 or work implement 14. Hydraulic actuator 16 may include a pair of fluid chambers—a first chamber 50 and a second chamber 52 that are separated by piston assembly 48. The first and second chambers 50, 52 may be selectively supplied with a fluid pressurized by source 24 and fluidly connected with tank 34 to cause piston assembly 48 to displace within tube 46, thereby changing the effective length of hydraulic actuator 16. The expansion and retraction of hydraulic actuator 16 may function to assist in moving work implement 14.

Piston assembly 48 may include a piston 54 axially aligned with and disposed within tube 46, and a piston rod 56 connectable to one of frame 12 and work implement 14 (referring to FIG. 1). Piston 54 may include a first hydraulic surface 58 and a second hydraulic surface 59 opposite first hydraulic surface 58. An imbalance of force caused by fluid pressure on first and second hydraulic surfaces 58, 59 may result in movement of piston assembly 48 within tube 46. For example, a force on first hydraulic surface 58 being greater than a force on second hydraulic surface 59 may cause piston assembly 48 to displace to increase the effective length of hydraulic actuator 16. Similarly, when a force on second hydraulic surface 59 is greater than a force on first hydraulic surface 58, piston assembly 48 will retract within tube 46 to decrease the effective length of hydraulic actuator 16. A sealing member (not shown), such as an o-ring, may be connected to piston 54 to restrict a flow of fluid between an internal wall of tube 46 and an outer cylindrical surface of piston 54.

Source 24 may be configured to produce a flow of pressurized fluid and may include a pump such as, for example, a variable displacement pump, a fixed displacement pump, or any other source of pressurized fluid known in the art. Source 24 may be drivably connected to a power source (not shown) of work machine 10 by, for example, a countershaft (not shown), a belt (not shown), an electrical circuit (not shown), or in any other suitable manner. Source 24 may be dedicated to supplying pressurized fluid to hydraulic system 22. Additionally or optionally, source 24 can also be configured to supply pressurized fluid to additional hydraulic systems 55 within work machine 10. In the illustrated embodiment of FIG. 2, the hydraulic system 55 may include a second hydraulic actuator. However, it can be contemplated to implement a second hydraulic motor in lieu of the second hydraulic actuator, if desired.

Hydraulic system 22 further includes a main relief line 88 fluidly coupled to a supply discharge line 114 extending from the source 24. The main relief line 88 includes a main relief valve 90 disposed therein. The main relief valve 90 is configured to open when fluid pressure in the supply discharge line 114 reaches a value equal to or greater than a pressure relief setting of the main relief valve 90.

Hydraulic system 22 further includes a bypass line 92 fluidly coupled to the supply discharge line 114. The bypass line 92 is disposed downstream of the main relief line 88 and upstream of the actuator valve system 86. The bypass line 92 includes a bypass valve 94 disposed therein. The bypass valve 94 is configured to selectively allow fluid communication between the main relief valve 90 and at least one of: the second hydraulic actuator 55 and the tank 34. Further explanation pertaining to the bypass valve 94 will be made later herein.

As shown in FIG. 2, the proportional pressure compensating valve 36 is fluidly coupled with the supply discharge line 114. Moreover, the pressure compensating valve 36 is disposed downstream of the first bypass line 92 and upstream of the actuator valve system 86. The pressure compensating valve 36 is configured to control a pressure of fluid directed between the source 24 and the first and second fluid chambers 50, 52 of the first hydraulic actuator 16 based on a load differential acting on the piston assembly 48 of the first hydraulic actuator 16. Further explanation pertaining to the proportional pressure compensating valve 36 will be made later herein.

As shown, the system 22 may further include a pair of check valves 76 and 96 located in the supply discharge line 114. The check valve 96 may be disposed downstream of the main relief line 88 and upstream of the bypass line 92 to prevent a backflow of fluid from the bypass line 92 to source 24. Moreover, the check valve 76 may be disposed upstream of the pressure compensating valve 36 and downstream of the actuator valve system 86 to prevent a backflow of fluid from the hydraulic actuator 16 to source 24. It is contemplated that hydraulic system 22 may include additional and/or different components to control fluid pressures and/or flows within hydraulic system 22.

The actuator valve system 86 is fluidly coupled to the supply discharge line 114. Moreover, as shown, the actuator valve system 86 is disposed downstream of the check valve 76 and upstream of the hydraulic actuator 16. In one example, the actuator valve system 86 is shown as an independent metering circuit, which includes electronically controlled valves such as a head-end supply valve 26, a head-end drain valve 28, a rod-end supply valve 30, and a rod-end drain valve 32. Although the actuator valve system 86 is depicted by way of an independent metering circuit in the illustrated embodiment of FIG. 2, in other embodiments, the actuator valve system 86 could be configured to optionally include other valve arrangements without deviating from the spirit of the present disclosure. Therefore, it may be noted that the independent metering circuit is merely exemplary in nature and hence, non-limiting of this disclosure. Although explanation pertaining to each one of these valves 26-32 is made hereinafter, embodiments of the present disclosure will be explained in conjunction with the head-end supply valve 26.

Head-end supply valve 26 may be disposed between source 24 and first chamber 50 and configured to regulate a flow of pressurized fluid to first chamber 50. Specifically, head-end supply valve 26 may include a two-position spring biased valve mechanism that is solenoid actuated and configured to move between a first position at which fluid is allowed to flow into first chamber 50 and a second position at which fluid flow is blocked from first chamber 50. It is contemplated that head-end supply valve 26 may include additional or different mechanisms such as, for example, a proportional valve element or any other valve mechanisms known in the art.

Head-end drain valve 28 may be disposed between first chamber 50 and tank 34 and configured to regulate a flow of pressurized fluid from first chamber 50 to tank 34. Specifically, head-end drain valve 28 may include a two-position spring biased valve mechanism that is solenoid actuated and configured to move between a first position at which fluid is allowed to flow from first chamber 50 and a second position at which fluid is blocked from flowing from first chamber 50. It is contemplated that head-end drain valve 28 may include additional or different valve mechanisms such as, for example, a proportional valve element or any other valve mechanism known in the art.

Rod-end supply valve 30 may be disposed between source 24 and second chamber 52 and configured to regulate a flow of pressurized fluid to second chamber 52. Specifically, rod-end supply valve 30 may include a two-position spring biased valve mechanism that is solenoid actuated and configured to move between a first position at which fluid is allowed to flow into second chamber 52 and a second position at which fluid is blocked from second chamber 52. It is contemplated that rod-end supply valve 30 may include additional or different valve mechanisms such as, for example, a proportional valve element or any other valve mechanism known in the art.

Rod-end drain valve 32 may be disposed between second chamber 52 and tank 34 and configured to regulate a flow of pressurized fluid from second chamber 52 to tank 34. Specifically, rod-end drain valve 32 may include a two-position spring biased valve mechanism that is solenoid actuated and configured to move between a first position at which fluid is allowed to flow from second chamber 52 and a second position at which fluid is blocked from flowing from second chamber 52. It is contemplated that rod-end drain valve 32 may include additional or different valve mechanisms such as, for example, a proportional valve element or any other valve mechanism known in the art.

Moreover, as shown, head-end and rod-end supply and drain valves 26-32 may be fluidly interconnected. In particular, head-end and rod-end supply valves 26, 30 may be connected in parallel to an upstream common fluid passageway 60 and connected to a downstream common fluid passageway 62. Moreover, the upstream common fluid passageway 60 is disposed in selective fluid communication with the supply discharge line vis-a-vis the check valve 76. Head-end and rod-end drain valves 28, 32 may be connected in parallel to a common drain passageway 64. Head-end supply and return valves 26, 28 may be connected in parallel to a first chamber fluid passageway 61 (hereinafter referred to as ‘line relief line’ and denoted by identical numeral ‘61’) that is disposed in selective fluid communication with the supply discharge line 114. Rod-end supply and return valves 30, 32 may be connected in parallel to a common second chamber fluid passageway 63 (hereinafter referred to as ‘line relief line’ and denoted by identical numeral ‘63’).

Hydraulic system 22 further includes a pair of line relief valves 38, 42 located in the line relief lines 61 and 63 respectively. The pair of line relief valves 38, 42 are disposed downstream of the corresponding supply valves 26 and 30 respectively. Each of these relief valves 38, 42 are configured to selectively facilitate a flow of fluid from the line relief lines 61 and 63 to tank 24 when a fluid pressure in line relief lines 61 and 63 is equal to or greater than a set pressure relief setting at the respective relief valves 38 and 42. Explanation pertaining to each of these valves 38, 42 is made hereinafter.

As shown, head-end pressure relief valve 38 is fluidly connected to line relief line 61 between first chamber 50 and head-end supply and drain valves 26, 28. Head-end pressure relief valve 38 may have a valve element spring biased toward a valve closing position. In a normally working condition, the valve element of the relief valve 38 may be movable to a valve opening position in response to a pressure within line relief line 61 being above a predetermined pressure. In this manner, head-end pressure relief valve 38 may be configured to reduce a pressure spike within hydraulic system 22 by allowing fluid from line relief line 61 to drain to tank 34.

Rod-end pressure relief valve 42 may be fluidly connected to line relief line 63 between second chamber 52 and rod-end supply and drain valves 30, 32. Rod-end pressure relief valve 42 may have a valve element spring biased toward a valve closing position and movable to a valve opening position in response to a pressure within line relief line 63 being above a predetermined pressure. In this manner, rod-end pressure relief valve 42 may be configured to reduce a pressure spike within hydraulic system 22 by allowing fluid from line relief line 63 to drain to tank 34.

In an exemplary embodiment as shown in FIG. 2, hydraulic system 22 could, additionally or optionally include, a head-end makeup valve 40 and a rod-end makeup valve 44. Head-end makeup valve 40 may be fluidly connected to line relief line 61 between first chamber 50 and head-end supply and drain valves 26, 28. Head-end makeup valve 40 may have a valve element configured to allow fluid from tank 34 into line relief line 61 in response to a fluid pressure within line relief line 61 being below a pressure of the fluid within tank 34. In this manner, head-end makeup valve 40 may be configured to reduce a drop in pressure within hydraulic system 22 by allowing fluid from tank 34 to fill first chamber 50.

Rod-end makeup valve 44 may be fluidly connected to line relief line 63 between second chamber 52 and rod-end supply and drain valves 30, 32. Rod-end makeup valve 44 may have a valve element configured to allow fluid from tank 34 into line relief line 63 in response to a fluid pressure within line relief line 63 being below a pressure of the fluid within tank 34. In this manner, rod-end makeup valve 44 may be configured to reduce a drop in pressure within hydraulic system 22 by allowing fluid from tank 34 to fill second chamber 52. However, it may be noted that the makeup valves 40 and 44 are merely exemplary in nature and hence, non-limiting of this disclosure. Embodiments of this disclosure may be realized with or without the presence of the makeup valves 40 and 44 without limiting the scope of the present disclosure.

Hydraulic system 22 may include additional components to control fluid pressures and/or flows within hydraulic system 22. Specifically, hydraulic system 22 may include a shuttle valve 74 that is disposed within downstream common fluid passageway 62. Shuttle valve 74 may be configured to fluidly connect the one of head-end and rod-end supply valves 26, 30 having a lower fluid pressure to proportional pressure compensating valve 36 in response to a higher fluid pressure from either head-end or rod-end supply valves 26, 30. In this manner, shuttle valve 74 may resolve pressure signals from head-end and rod-end supply valves 26, 30 to allow the lower outlet pressure of the two valves to affect movement of proportional pressure compensating valve 36.

Tank 34 may constitute a reservoir configured to hold a supply of fluid. The fluid may include, for example, a specific grade of oil, an engine lubrication oil, a transmission lubrication oil, or any other fluid known in the art. One or more hydraulic systems within work machine 10 may draw fluid from and return fluid to tank 34. It is also contemplated that hydraulic system 22 may be connected to multiple separate fluid tanks.

Proportional pressure compensating valve 36 may be a hydro-mechanically actuated proportional control valve disposed between upstream common fluid passageway 60 and source 24, and may be configured to control a pressure of the fluid supplied to upstream common fluid passageway 60. Specifically, proportional pressure compensating valve 36 may include a valve element that is spring biased and hydraulically biased toward a flow passing position and movable by hydraulic pressure toward a flow blocking position. In one embodiment, proportional pressure compensating valve 36 may be movable toward the flow blocking position by a fluid directed via a fluid passageway 78 from a point between proportional pressure compensating valve 36 and check valve 76. A restrictive orifice 80 may be disposed within fluid passageway 78 to minimize pressure and/or flow oscillations within fluid passageway 78. Proportional pressure compensating valve 36 may be movable toward the flow passing position by a fluid directed via a fluid passageway 82 from shuttle valve 74. A restrictive orifice 84 may be disposed within fluid passageway 82 to minimize pressure and/or flow oscillations within fluid passageway 82. It is contemplated that the valve element of proportional pressure compensating valve 36 may alternately be spring biased toward a flow blocking position, that the fluid from passageway 82 may alternately bias the valve element of proportional pressure compensating valve 36 toward the flow passing position, and/or that the fluid from passageway 78 may alternately move the valve element of proportional pressure compensating valve 36 toward the flow blocking position. It is also contemplated that restrictive orifices 80 and 84 may be omitted, if desired.

Hydraulic system 22 further includes a plurality of pressure sensors 104-108. As shown in FIG. 2, pressure sensor 104 may be coupled to the supply discharge line 114 and disposed upstream of the main relief line 88. Alternatively, the first pressure sensor 104 could be located in the main relief line 88. The pressure sensor 104 is configured to indicate a fluid pressure of the main relief line 88. For purposes of the present disclosure, the pressure sensor 104 may be regarded as ‘the first pressure sensor’ and denoted with identical numeral ‘104’.

Pressure sensor 106 may be coupled to the line relief line 61 and disposed upstream of the line relief valve 38. Pressure sensor 106 is configured to measure a fluid pressure within line relief line 61 i.e., a pressure of fluid between first chamber 50, head-end supply valve 26, head-end drain valve 28, and line relief valve 96.

Similarly, pressure sensor 108 is coupled to the line relief line 63 and disposed upstream of the line relief valve 42. Pressure sensor 108 is configured to measure a fluid pressure within line relief line 63 i.e., a pressure of fluid between second chamber 52, rod-end supply valve 30, rod-end drain valve 32, and line relief valve 42.

Hydraulic system 22 further includes a controller 102 communicably coupled to the source 24, the bypass valve 94, the head-end and rod-end supply and drain valves 26, 28, 30, 32; and the pressure sensors 104-108 associated with the supply discharge line 114 and the line relief lines 61, 63 respectively. Explanation pertaining to functions of the controller 102 will be made hereinafter. The present disclosure relates to determining leakage across any one of the line relief valves 38 or 42; or the main relief valve 90. Moreover, embodiments of the present disclosure are also directed to determining if any one of the line relief valves 38 or 42 is not functioning at a set or desired pressure value.

In various embodiments of this disclosure, the controller 102 of the present disclosure is configured to receive feedback signals from each of the pressure sensors 104-108. These feedback signals are indicative of current fluid pressures in the main relief line 88 and each of the line relief lines 61, 63 respectively. For the sake of convenience and brevity in this document, the present disclosure will be explained in conjunction with hydraulic components associated with the supply discharge 114, and the line relief line 61. However, it may be noted that such explanation can be similarly applied to hydraulic components associated with the supply discharge 114, and the line relief line 63 without deviating from the spirit of the present disclosure. Explanation pertaining to a determination of leakage across the line relief valves 38 will be made hereinafter.

In order to determine if the line relief valve 38 is leaking, the main relief valve 90 is set to open at a first pressure value. Further, the line relief valve 38 is set to open at a second pressure value that is greater than the first pressure value setting associated with the main relief valve 90. Moreover, the source 24 is configured to output fluid at a pressure lesser than the first pressure value associated with the main relief valve 90.

In various embodiments of this disclosure, the controller 102 can beneficially vary an amount of discharge and pressure of fluid from the source 24 with the help of a pump displacement control unit 112, as shown in FIG. 2. The pump displacement control unit 112 may include any system hardware known to persons skilled in the art such as, but not limited to, a swash plate of an axial piston pump, for bringing about a change in the displacement of the source 24 and therefore, vary an amount of discharge and pressure of fluid output from the source 24. However, in an alternative embodiment of this disclosure, the controller 102 can also control the bypass valve 94 to regulate the pressure of fluid output by the source 24 to a pressure value lesser than the first pressure value setting associated with the main relief valve 90. Specifically, the controller 102 may move the bypass valve 94 to an open position associated with a desired flow rate from the source 24 so as to regulate the pressure of fluid output by the source 24 to a pressure value lesser than the first pressure value associated with the main relief valve 90.

For determining a leakage in the line relief valve 38, the controller 102 is configured to move the supply valve 26 to an open position to fill the first chamber 50 of the actuator 16 with pressurized fluid output from the source 24. Such filling up of the first chamber 50 would be carried until the piston assembly 48 can implement a fully extended position of the hydraulic actuator 16. Thereafter, the controller 102 is configured to move the supply valve 26 to an open position correlating to a maximum pressure drop across the supply valve 26 i.e., the controller would cause a minimal displacement (towards open position of the supply valve 26) in the valve element of the supply valve 26 to implement a large or maximum pressure drop across the supply valve 26. Upon such opening with minimal displacement in the valve element of the supply valve 26, fluid from the source 24 may or may not continue to be urged into the line relief line 61 depending on whether the line relief valve 38 has failed or is working at the desired pressure setting i.e., the second pressure value.

The controller 102 is then configured to determine the fluid pressure of the main relief line 88 with the help of the first pressure sensor 104. The controller 102 is also configured to determine the fluid pressure of the line relief line 61 with the help of the second pressure sensor 106. Thereafter, the controller 102 is configured to compare the fluid pressures of the main relief line 88 and the line relief line 61 and determine leakage across the line relief valve 38 on the basis of a difference between the fluid pressures of the main relief line 88 and the line relief line 61.

For example, if the pressure in the main relief line is P1 and the pressure in the line relief line is P2, the controller 102 may determine AP from the difference between P1 and P2 i.e., ΔP=|P1−P2| . . . equation 1. If the pressure P2 of fluid in the line relief line 61 is lower than pressure P1 in the main relief line 88, then the controller 102 can determine from equation 1 that the line relief valve 38 is leaking. However, if there is no difference in the pressures P1 and P2, then the controller can use equation 1 to determine that the line relief valve 38 is functioning properly.

It may be noted that the controller 102 may be configured with suitable equations, algorithms, look-up tables, statistical data, theoretical models, trail and experimental data, but not limited thereto. For example, the controller 102 may determine flow Q across line relief valve 38 using equation 2 below:

Q=c_{d}.A.√(2.(ΔP/ρ)) equation 2; wherein
Q=flow
c_{d}=discharge co-efficient
A=Stem Area
ΔP=P1−P2 . . . Pressure difference between pressure sensors 104 and 106
ρ=fluid density

For determining a leakage in the main relief valve 90, the controller 102 is configured to move the supply valve 26 into a closed position. Thereafter, the main relief valve 90 is set to open at a first pressure value P3. In the specific embodiment of FIG. 2, supply valve 30 may also be moved into the closed position to prevent any fluid from source entering the fluid chambers 50, 52 of the hydraulic actuator. The controller 102 may then move the bypass valve 94 to a position that corresponds to maintaining a discharge pressure P4 from the source 24 lower than the first pressure value setting P3 associated with the main relief valve 90.

Controller 102 may compare the first pressure value setting P3 of the main relief valve 90 with the discharge pressure P4 of fluid to determine if the main relief valve 88 is leaking. The comparison may be accomplished by determining a difference ΔP between P3 and P4, represented mathematically by for e.g., equation 3 below:

ΔP=|P3−P4| equation 3.

If ΔP from equation 3 is greater than zero, the controller 102 determines that the main relief line 90 is leaking. If ΔP from equation 3 is equal to zero, the controller 102 determines that the main relief line 90 is functioning properly.

In order to determine if the line relief valve 38 is opening at a set or desired pressure value, the main relief valve 90 is set to open at a first pressure value. Further, the line relief valve 38 is set to open at a second pressure value that is lesser than the first pressure value setting associated with the main relief valve 90. Moreover, the source 24 is configured to output fluid at a pressure lesser than the first pressure value associated with the main relief valve 90.

The controller 102 is then configured to move the supply valve 26 to an open position to fill the first chamber 50 of the actuator 16 with pressurized fluid output from the source 24. Such filling up of the first chamber 50 would be carried until the piston assembly 48 can implement a fully extended position of the hydraulic actuator 16. Thereafter, the controller 102 is configured to move the supply valve 26 to an open position correlating to a minimum to zero pressure drop across the supply valve 26 i.e., the controller would cause a maximum displacement (towards open position of the supply valve 26) in the valve element of the supply valve 26 to implement a minimum to zero pressure drop across the supply valve 26. Upon such opening with maximum displacement in the valve element of the supply valve 26, fluid from the source 24 may or may not continue to be urged into the line relief line 61 depending on whether the line relief valve 38 has failed or is working at the desired pressure setting i.e., the second pressure value.

The controller 102 is then configured to determine the fluid pressure of the line relief line 61 with the help of the second pressure sensor 106. Thereafter, the controller 102 is configured to compare the fluid pressure of the line relief line 61 with the second pressure value setting associated with the line relief valve 38 and determine if the line relief valve 38 is opening at the second pressure value on the basis of a difference between the fluid pressure of the line relief line 61 with the second pressure value setting associated with the line relief valve 38.

For example, if the pressure of fluid in the line relief line is P2 and the second pressure value setting associated with the line relief valve 38 is P5, the controller 102 may determine AP from the difference between P2 and P5 i.e., ΔP=|P5−P2 . . . equation 4. Thereafter, the controller 102 may determine the amount of flow or leakage across the line relief valve 38 using equation 2 given below.

Q=c_{d}.A.√(2.(ΔP/ρ)) wherein, it should be noted that ΔP is substituted, in this case, with the difference between pressure P2 from pressure sensor 106 and second pressure value setting P5 associated with line relief valve i.e., |P5−P2|.

Although embodiments of the present disclosure are explained in terms of ΔP being equal to zero for indicating a proper functioning of the line relief valve 38 and the main relief valve 90; and also for determining the setting of the line relief valve 38 and the main relief valve 90, persons having ordinary skill in the art will acknowledge that in many cases, pressure signals from the pressure sensors for e.g., pressure sensors 104 and 106 could include noise that can impact the pressure values P1, P2, and P4 indicated by the pressure sensors 104, 106 to the controller 102. However, it should be noted that noise may not affect P3 and P5 as P3 and P5 are disclosed as the pressure settings associated with the main relief valve 90 and the line relief valve 38 respectively.

Taking noise into account, the difference ΔP computed between pressures P1 and P2 (vide equation 1) can be understood as being below a first pre-defined value to indicate proper functioning i.e., a no-leakage condition of the line relief valve 38. Likewise, ΔP computed between pressure setting P3 and pressure value P4 (vide equation 3) can be understood as being below a second pre-defined value to indicate proper functioning i.e., a no-leakage condition of the main relief valve 90. Similarly, ΔP computed between pressure setting P5 and pressure value P2 (vide equation 4) can be understood as being below a third pre-defined value to indicate proper functioning of the line relief valve 38 i.e., the line relief valve 38 working at the desired or set pressure setting i.e., intended pressure setting—in this case pressure setting P5. The first, second, and third pre-defined values disclosed herein are hereby contemplated as being greater than zero assuming that the flow rates in the respective fluid lines of the hydraulic system 22 are high enough to allow pressure sensors 104 and 106 in determining the respective pressures P1, P2, and P4.

Therefore, it should be noted that although AP in equations 1, 3, and 4 can theoretically take the value of zero; for practical purposes, ΔP from equations 1, 3, and 4 should be within the respective pre-defined values i.e., the first pre-defined value, the second pre-defined value, or the third pre-defined value depending on the relief valve 38/90 for which a check is performed.

In another embodiment of this disclosure, it can also be contemplated to introduce a compensating factor or offset value corresponding to the amount of noise in the pressure signals so that the pressure values P1, P2, and P4 are adjusted and/or corrected so as to be devoid of noise therein. Therefore, numerous modifications and/or strategies can be contemplated in the determination of P1, P2, and P4 and/or a computation of the respective ΔP by persons skilled in the art without limiting the scope of the present disclosure and deviating from the spirit of the present disclosure. Accordingly, it should be noted that the claims appended herein are not limited to AP being equal to zero, rather a scope of the appended claims extend to include such modifications and/or strategies being part of the determination and computation process disclosed herein.

In another embodiment of this disclosure, the controller 102 may be associated with suitable system hardware (not shown) such as, but not limited to, a visual display interface for e.g., a graphical user interface (GUI); an audio interface, and the like. Such system hardware may be beneficially provided to alert an operator in the event of an improper functioning of any relief valve for e.g., relief valves 38, 42, 90. Improper functioning disclosed herein can include leakage of a given relief valve, and/or failure of a given relief valve to operate at the intended pressure setting i.e., desired or set pressure setting.

It may be noted that in embodiments of the present disclosure, the controller 102 is configured with suitable algorithms, programs, circuitry such as, but not limited to, power supply circuitry, signal conditioning circuitry, solenoid driver circuitry, alarm driving circuitry, and the like for executing functionality consistent with the present disclosure. Moreover, algorithms and programs associated with the controller 102 can reside on one or more devices known to persons skilled in the art. Some examples of such devices may include, but is not limited to, read only memory (ROM), random access memory (RAM), floppy disks, compact disks, portable hard disks, and the like. Such devices may be contemplated and suitably implemented by one skilled in the art, in conjunction with the controller 102 to execute functions that are consistent with the present disclosure.

### INDUSTRIAL APPLICABILITY

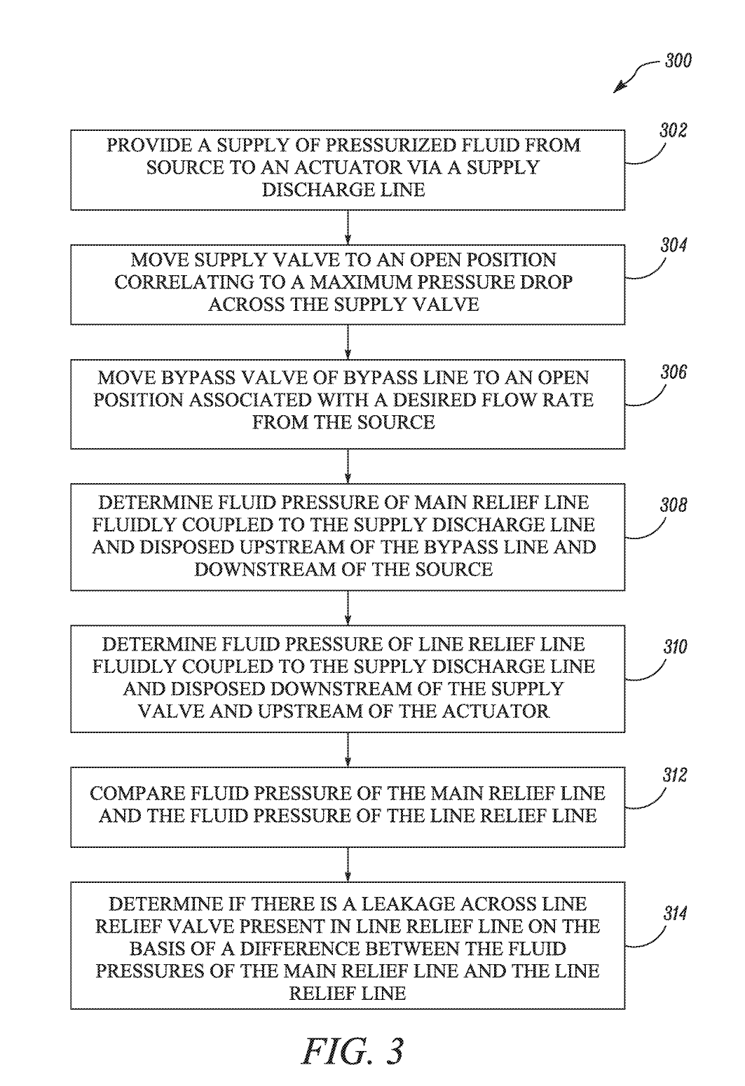

Referring to FIG. 3, a method 300 of monitoring performance of line relief valve 38 or 42 in the hydraulic system 22 is illustrated. The method 300 will be explained in conjunction with the supply valve 26 and the line relief valve 38 of the hydraulic system 22. However, it should be noted that although the method 300 is explained in conjunction with the supply valve 26 and the line relief valve 38, such method 300 can be similarly applied for determining leakage in line relief valve 42. Also, it can be alternatively contemplated to implement the method 300 in other types of machines that are typically known to include relief valves for functioning of various hydraulic components associated with a given machine.

At step 302, the method 300 includes providing a supply of pressurized fluid from source 24 to the actuator 16 for e.g., the first chamber 50 of actuator 16 via the supply discharge line 114. At step 304, the method 300 further includes moving the supply valve 26 to an open position correlating to a maximum pressure drop across the supply valve 26. In an embodiment, prior to performing step 304, the method 300 may include moving the supply valve 26 to an open position so as to fill the first chamber 50 of the hydraulic actuator 16.

At step 306, the method 300 further includes moving bypass valve 94 of bypass line 92 to an open position associated with a desired flow rate from the source 24. As such, moving the bypass valve 94 can help in maintaining the discharge pressure from source 24 to a pressure value lower than the first pressure value setting associated with the main relief valve 90.

At step 308, the method 300 further includes determining fluid pressure P1 of main relief line 88 from first pressure sensor 104. At step 310, the method 300 further includes determining fluid pressure P2 of line relief line 61 from second pressure sensor 106. Thereafter, at step 312, the method 300 further includes comparing fluid pressure P1 of the main relief line 88 and the fluid pressure P2 of the line relief line 61. At step 314, the method 300 further includes determining if there is a leakage across line relief valve 38 present in line relief line 61 on the basis of a difference i.e., |P1−P2| between the fluid pressures P1 and P2 of the main relief line 88 and the line relief line 61 respectively.

The disclosed hydraulic system may be applicable to any work machine that includes one or more relief valves to execute a functionality of actuators and other hydraulic components in a hydraulic system associated with the work machine. Embodiments of the present disclosure can help service personnel in determining leakage associated with relief valves easily and quickly. This way, technicians can save significant costs, time, and effort previously associated with performing conventional manual checks on the relief valves. With implementation of the present disclosure, operators of machines can help reduce downtime associated with the machines and resume operation on a worksite.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof

What is claimed is:

1. A system for monitoring performance of a relief valve in a hydraulic system having at least one hydraulic actuator, the system comprising:
a source configured to provide a supply of pressurized fluid;
a supply discharge line fluidly coupled between the source and a fluid chamber of the actuator;
a main relief line fluidly coupled to the supply discharge line, the main relief line comprising a main relief valve disposed therein, the main relief valve being configured to regulate a pressure of the fluid from the source below a first pressure value;
an electronically controlled supply valve disposed downstream of the main relief line and fluidly coupled to the supply discharge line, the supply valve configured to selectively communicate pressurized fluid from the source to the fluid chamber of the actuator;
a line relief line disposed between the fluid chamber of the actuator and the supply valve and fluidly coupled to the supply discharge line, the line relief line comprising a line relief valve being configured to open at a second pressure value greater than the first pressure value to selectively facilitate fluid communication between the fluid chamber of the hydraulic actuator and a tank;
a bypass line fluidly coupled to the supply discharge line and disposed between the main relief line and the supply valve, the bypass line comprising a bypass valve disposed therein, the bypass valve configured to selectively allow fluid communication between the supply discharge line and at least one of: a second hydraulic actuator and the tank;
a first pressure sensor coupled to the supply discharge line and disposed upstream of the supply valve to indicate a fluid pressure of the main relief line;
a second pressure sensor coupled to the line relief line and disposed upstream of the line relief valve to indicate a fluid pressure of the line relief line; and
a controller disposed in communication with the supply valve, bypass valve, the first pressure sensor, and the second pressure sensor, the controller configured to:
move the supply valve to an open position correlating to a maximum pressure drop across the supply valve;
provide the supply of pressurized fluid from the source;
move the bypass valve to an open position associated with a desired flow rate from the source;
determine the fluid pressure of the main relief line;
determine the fluid pressure of the line relief line;
compare the fluid pressure of the main relief line and the fluid pressure of the line relief line; and
determine leakage across the line relief valve on the basis of a difference between the fluid pressures of the main relief line and the line relief line.

2. The system of claim 1, wherein the source is configured to output fluid in the supply discharge line at a pressure lower than the first pressure value associated with the main relief valve.

3. The system of claim 2, wherein the controller determines failure of the main relief valve if fluid from the source flows across the main relief valve.

4. The system of claim 1, wherein the controller is configured to fill the fluid chamber of the hydraulic actuator prior to moving the supply valve to the open position.

5. The system of claim 1 further comprising a proportional pressure compensating valve disposed downstream of the main relief valve, the proportional pressure compensating valve configured to control a pressure of fluid directed between the source and the fluid chambers of the hydraulic actuator based on a load differential acting on a piston assembly of the hydraulic actuator.

6. The system of claim 1, wherein the main relief valve and the line relief valve is further disposed in direct fluid communication with the tank via respective auxiliary fluid lines.

7. The system of claim 1 further comprising an electronically controlled drain valve located downstream of the supply valve and disposed in parallel relation to the line relief valve, the drain valve configured to selectively communicate a return flow of fluid from the fluid chamber of the hydraulic actuator to the tank.

8. The system of claim 1, wherein the controller is communicably coupled to the source, the controller configured to control a discharge flow rate and pressure of fluid output from the source.

9. A system for monitoring performance of a relief valve in a hydraulic system having at least one hydraulic actuator, the system comprising:
a source configured to provide a supply of pressurized fluid;
a supply discharge line fluidly coupled between the source and a fluid chamber of the actuator;
a main relief line fluidly coupled to the supply discharge line, the main relief line comprising a main relief valve disposed therein, the main relief valve being configured to regulate a pressure of the fluid from the source below a first pressure value;
an electronically controlled supply valve disposed downstream of the main relief line and fluidly coupled to the supply discharge line, the supply valve configured to selectively communicate pressurized fluid from the source to the fluid chamber of the actuator;
a line relief line disposed between the fluid chamber of the actuator and the supply valve and fluidly coupled to the supply discharge line, the line relief line comprising a line relief valve being configured to open at a second pressure value greater than the first pressure value to selectively facilitate fluid communication between the fluid chamber of the hydraulic actuator and a tank;
a bypass line fluidly coupled to the supply discharge line and disposed between the main relief line and the supply valve, the bypass line comprising a bypass valve disposed therein, the bypass valve configured to selectively allow fluid communication between the supply discharge line and at least one of: a second hydraulic actuator and the tank;
a first pressure sensor coupled to the supply discharge line and disposed upstream of the supply valve to indicate a fluid pressure of the main relief line;
a second pressure sensor coupled to the line relief line and disposed upstream of the line relief valve to indicate a fluid pressure of the line relief line; and
a controller disposed in communication with the supply valve, bypass valve, the first pressure sensor, and the second pressure sensor, the controller configured to:
move the supply valve to an open position correlating to a minimum to zero pressure drop across the supply valve;
provide the supply of pressurized fluid from the source;
move the bypass valve to an open position associated with a desired flow rate from the source;
determine a pressure of fluid in the line relief line;
compare the pressure of fluid in the line relief line from the second pressure sensor with the second pressure value associated with the line relief valve; and
determine if the line relief valve is opening at the second pressure value on the basis of a difference between the pressure of fluid in the line relief line and the second pressure value at which the second relief valve is set to open.

10. The system of claim 9, wherein the source is configured to output fluid in the supply discharge line at a pressure lower than the first pressure value associated with the main relief valve.

11. The system of claim 10, wherein the controller determines failure of the main relief valve if fluid from the source flows across the main relief valve.

12. The system of claim 9, wherein the controller is configured to fill the fluid chamber of the hydraulic actuator prior to moving the supply valve to the open position.

13. The system of claim 9 further comprising a proportional pressure compensating valve disposed downstream of the main relief valve, the proportional pressure compensating valve configured to control a pressure of fluid directed between the source and the fluid chambers of the hydraulic actuator based on a load differential acting on a piston assembly of the hydraulic actuator.

14. The system of claim 9, wherein the main relief valve and the line relief valve is further disposed in direct fluid communication with the tank via respective auxiliary fluid lines.

15. The system of claim 9 further comprising an electronically controlled drain valve located downstream of the supply valve and disposed in parallel relation to the line relief valve, the drain valve configured to selectively communicate a return flow of fluid from the fluid chamber of the hydraulic actuator to the tank.

16. A method for monitoring performance of a relief valve in a hydraulic system, the method comprising:
providing a supply of pressurized fluid from a source to an actuator via a supply discharge line;
moving a supply valve to an open position correlating to a maximum pressure drop across the supply valve, wherein the supply valve is fluidly coupled to the supply discharge line between the source and the actuator;
moving a bypass valve of a bypass line to an open position associated with a desired flow rate from the source, wherein the bypass line is coupled to the supply discharge line, the bypass line being disposed upstream of the supply valve and downstream of the source;
determining a fluid pressure of a main relief line, wherein the main relief line is fluidly coupled to the supply discharge line, the main relief line being disposed upstream of the bypass line and downstream of the source, the main relief line having a main relief valve disposed therein;
determining a fluid pressure of a line relief line, wherein the line relief line is fluidly coupled to the supply discharge line, the line relief line being disposed downstream of the supply valve and upstream of the actuator, the line relief line comprising a line relief valve disposed therein;
comparing the fluid pressure of the main relief line and the fluid pressure of the line relief line; and
determining if there is a leakage across the line relief valve on the basis of a difference between the fluid pressures of the main relief line and the line relief line.

17. The method of claim 16, wherein the main relief valve is configured to open at a first pressure value, the line relief valve is configured to open at a second pressure value greater than the first pressure value.

18. The method of claim 17, wherein the fluid is supplied to the supply discharge line at a pressure lower than the first pressure value associated with the main relief valve.

19. The method of claim 16 further comprising determining failure of the main relief valve if fluid from the source flows across the main relief valve.

20. The method of claim 17 further comprising filling the fluid chamber of the actuator prior to moving the supply valve to the open position.
